(19) United States
(12) Patent Application Publication
(10) Pub. No.: US 2017/0150105 A1
(43) Pub. Date: May 25, 2017

(54) IMAGE DELIVERY APPARATUS, IMAGE DELIVERY METHOD, AND COMPUTER-READABLE MEDIUM

(71) Applicant: CASIO COMPUTER CO., LTD., Tokyo (JP)

(72) Inventors: Hirokazu KANDA, Ome-shi (JP); Atsushi NAKAMURA, Ome-shi (JP)

(73) Assignee: CASIO COMPUTER CO., LTD., Tokyo (JP)

(21) Appl. No.: 15/422,063

(22) Filed: Feb. 1, 2017

Related U.S. Application Data
(63) Continuation of application No. PCT/JP2015/072873, filed on Aug. 12, 2015.

(30) Foreign Application Priority Data
Sep. 17, 2014 (JP) 2014-189353

(51) Int. Cl. H04N 9/31; G03B 21/10; G03B 21/56; G09G 3/20

(52) U.S. Cl. CPC H04N 9/3141; G09G 3/2092; H04N 9/3185; G03B 21/10; G03B 21/56

(57) ABSTRACT

An image delivery method comprising: an acceptance step (S102) of accepting a delivery request of content from an external device, a shape acquisition step (S102, 5109) of acquiring information indicating a shape of a screen which the external device includes, a detection step (S109) of detecting the shape of the screen which is suited to image projection of the content stored in a database (DB), and a delivery step (S112) of delivering the content, which is stored in the database (DB), to the external device accepted in the acceptance step (S102), in accordance with the information acquired in the shape acquisition step (S102, 5109) and the shape of the screen detected in the detection step (S109).

### CROSS-REFERENCE TO RELATED APPLICATIONS

This application is a Continuation Application of PCT Application No. PCT/JP2015/072873, filed Aug. 12, 2015, and based upon and claiming the benefit of Japanese Patent Application No. 2014-189353, filed Sep. 17, 2014, the entire contents of which are incorporated herein by reference.

### BACKGROUND OF THE INVENTION

1. Field of the Invention

The present invention relates to an image delivery apparatus, an image delivery method and a computer-readable medium, which deliver images to a plurality of projecting apparatuses which are disposed, for example, on sales floors of stores, and introduce various kinds of goods.

2. Description of the Related Art

There has been proposed a video output device-equipped apparatus configured to project video content on a screen of a non-fixed shape, such as a human shape, by rear projection, thereby to enhance an impression on a viewer (e.g. patent document 1).

### CITATION LIST

### Patent Literature

Patent document 1: Jpn. Pat. Appln. KOKAI Publication No. 2011-150221

### BRIEF SUMMARY OF THE INVENTION

In techniques including the technique disclosed in the above patent document, when a screen of a non-fixed shape, which does not agree with the shape of a projectable area, is used in a replaceable manner, in particular, in a projection apparatus of a rear-projection method, if an image, which does not agree with the shape of the screen, is played back, there is concern that light, which is out of the range of the screen, is directly radiated to a viewer who is positioned in front of the apparatus. Thus, in this kind of apparatus, it is necessary to acquire an image which exactly agrees with the shape of the screen that is mounted on the apparatus.

On the other hand, on many occasions, this kind of projection apparatus is disposed, for example, at the front of a store where many goods are displayed. Since the goods that are recommended by the store are changed from time to time, the image data to be played back needs to be also changed frequently.

Thus, in particular, when a person in charge, who is unfamiliar with the management and handling of the projection apparatus, tries to acquire image data of new goods, it is possible that the person incorrectly acquires image data for a screen of a different shape, and, in an actual projection operation, projection light, which is out of the range of the screen, is radiated to the front side of the apparatus, as described above.

The present invention has been made in consideration of the above circumstance, and the object of the invention is to provide an image delivery apparatus, an image delivery method and a computer-readable medium, which are capable of delivering image content to a projection apparatus on which a screen panel of a non-fixed shape is mounted, after exactly recognizing the shape of the mounted screen panel.

According to one embodiment of the present invention, an image delivery apparatus comprising: a storage configured to store content including an image; and a communicator configured to: accept a delivery request of content from an external device; acquire information indicating a shape of a screen which the external device includes; and deliver the content, which is stored in the storage, to the external device in accordance with the acquired information.

According to the present invention, image content can be delivered to a projection apparatus on which a screen panel of a non-fixed shape is mounted, after the shape of the mounted screen panel is exactly recognized.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view illustrating the configuration of the entirety of a system according to an embodiment of the present invention.

FIG. 2 is a perspective view illustrating the configuration of the external appearance of a signage device according to the embodiment.

FIG. 3 is a cross-sectional view illustrating mainly the configuration of a projection optics system, as viewed from a right side surface side, which is provided on the signage device according to the embodiment.

FIG. 4 is a flowchart illustrating, in an extracted manner, the content of a part of a process which is executed by a content delivery server according to the embodiment.

FIG. 5A is a view illustrating an example of the shape of a screen panel which is used in the signage device according to the embodiment.

FIG. 5B is a view illustrating an example of the shape of the screen panel which is used in the signage device according to the embodiment.

FIG. 6A is a view illustrating an example of a pixel configuration of moving image data which a personal computer according to the embodiment uploads to the content delivery server.

FIG. 6B is a view illustrating an example of the pixel configuration of moving image data which the personal computer according to the embodiment uploads to the content delivery server.

### DETAILED DESCRIPTION OF THE INVENTION

Hereinafter, referring to the accompanying drawings, a description is given of an embodiment in a case in which the present invention was applied to an image delivery system which delivers content including images to signage devices which are used in a plurality of stores.

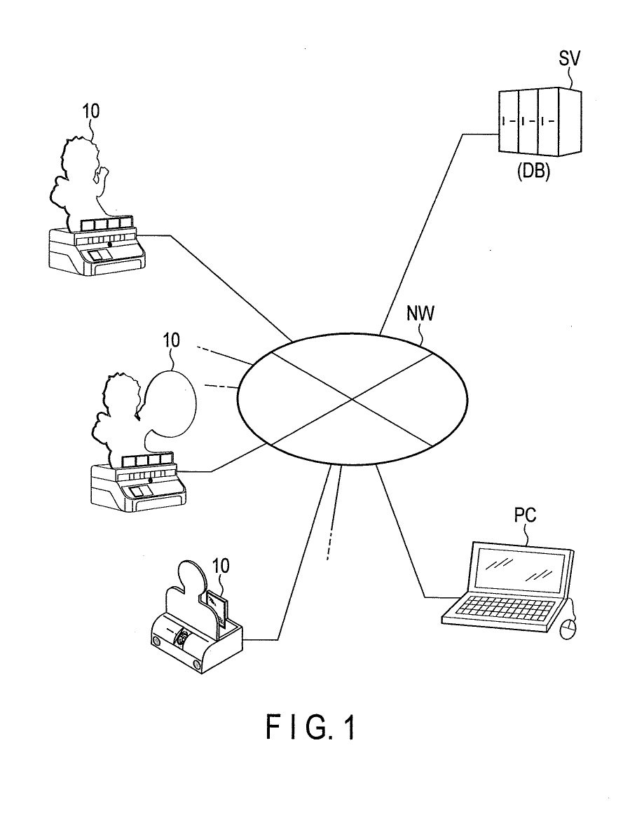

FIG. 1 is a block diagram illustrating a configuration of connections of the entirety of the system. A plurality of signage devices 10, which are disposed in a plurality of stores, are connected to an external content delivery server SV via a network NW including a wireless LAN and the Internet.

Furthermore, a personal computer PC, which executes management and content update of the content delivery server SV, is connected via the network NW.

The content delivery server SV includes a database (DB) which stores a great number of contents composed of moving image data with audio data, which are designed to promote, for example, sales of goods by the signage devices 10 in the respective stores.

Screen panels of different shapes can be selectively mounted on the individual signage devices 10. Since the content delivery server SV provides content data to the respective signage devices 10, the content delivery server SV acquires in advance identification information indicating the shapes of the screen panels which are mounted on the respective signage devices 10, and stores in the database the identification information by associating the identification information with identification ID information of the signage devices 10.

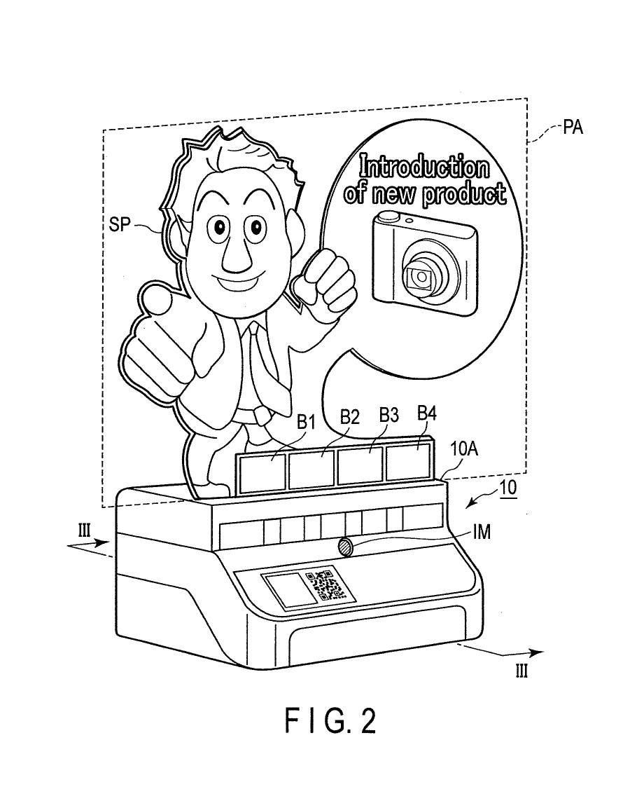

FIG. 2 is a perspective view illustrating the configuration of the external appearance of one of the signage devices 10. The digital signage device 10 is an electronic mannequin using a projector technique. A screen panel SP is provided upright on a front end side of the top surface of an apparatus housing 10A. The screen panel SP has a semitransparent plate-like configuration with an arbitrary shape, and the screen panel SP is disposed so as to fall within a normally rectangular projectable area PA of the signage device 10.

An optical image that is emitted from a projection lens (not shown) of a rear projection method, which is provided on the top surface of the apparatus housing 10A, is projected from the rear side of the screen panel SP. Thereby, the screen panel SP displays, for example, an image as illustrated in the Figure.

A plurality of, or four in this embodiment, operation buttons B1 to B4 are projected in combination on a lower part of the screen panel SP. When any one of the buttons was touch-operated by a viewer, the position of this operation can be detected by a line-shaped array of infrared sensors with directivities, which are disposed on a board attachment base portion.

In addition, on the front surface of the apparatus housing 10A, there is provided an imaging unit IM for photographing, for example, a person who is positioned in front of the digital signage device 10.

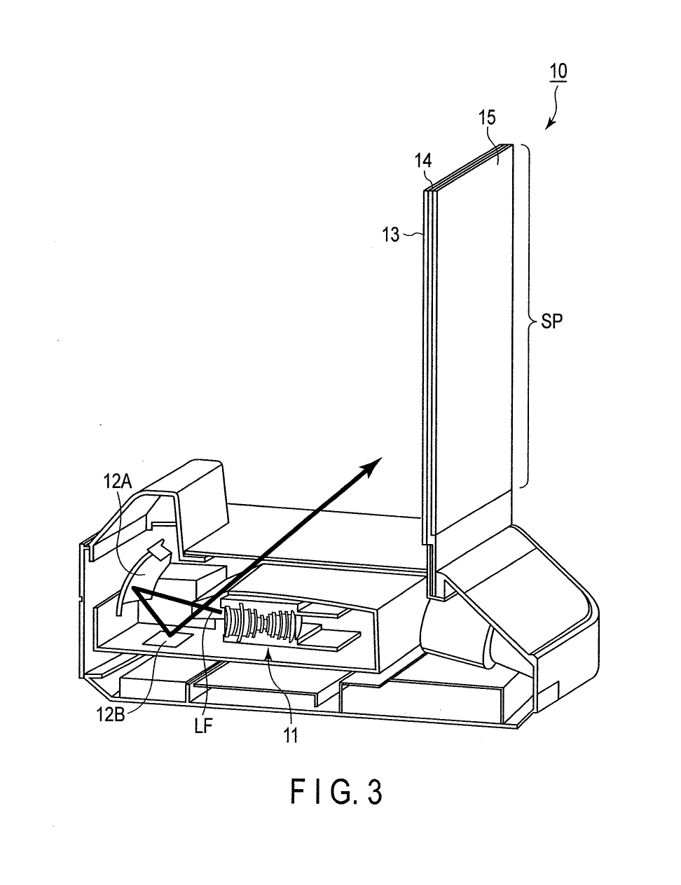

FIG. 3 is a view taken along line in FIG. 2, and mainly illustrates a cross-sectional configuration of a projection optics system, as viewed from a right side surface side, which is provided on the signage device 10.

A projection luminous flux LF, which was emitted from a projection lens 11 in an obliquely upward direction to the rear side, is reflected in a downward direction to the front side by a first total-reflection mirror 12A which has a concave shape. Then, the luminous flux LF is further reflected by a second total-reflection mirror 12B which is horizontal, and is projected onto a plate-shaped Fresnel lens 13 in an obliquely upward direction to the front side. Thus, the luminous flux LF is deflected into a luminous flux which is parallel to the surface on which the apparatus is disposed.

The projection luminous flux LF, which was deflected by the Fresnel lens 13, is projected onto a semitransparent screen 14 which is formed integral with the Fresnel lens 13.

A transparent board 15 is integrally formed on a front side of the screen 14. The three layers of the Fresnel lens 13, screen 14 and transparent board 15 are integrated to form the above-described screen panel SP.

As regards the configuration of a server computer which constitutes the above-described content delivery server SV, and the configuration of hardware circuitry of the personal computer PC, illustrations and descriptions thereof are omitted since these are the same as in well-known art.

Next, the operation of the above-described embodiment is described.

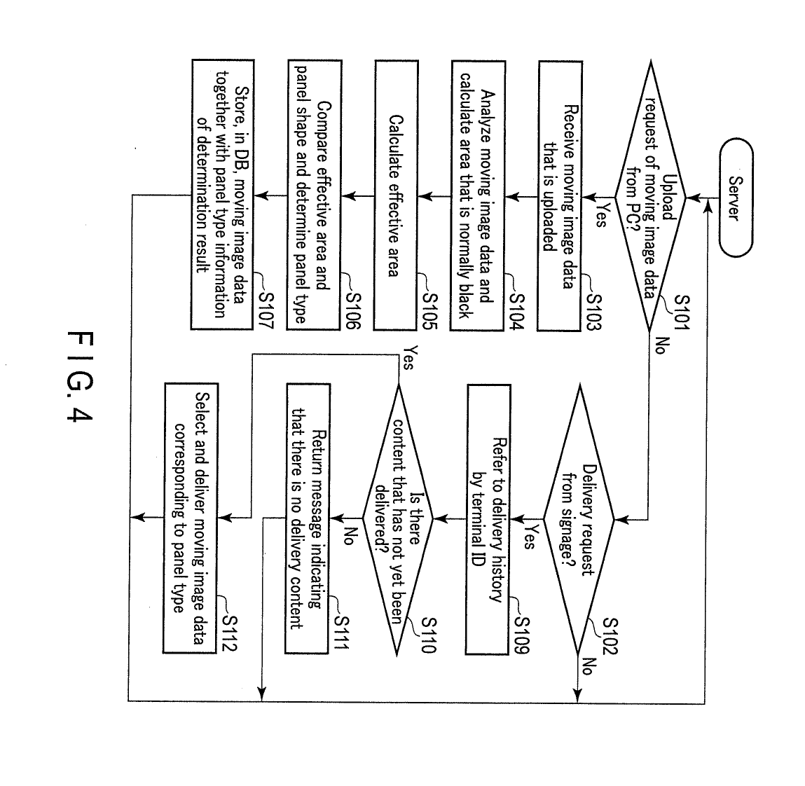

FIG. 4 is a flowchart illustrating, in an extracted manner, the content of a part of a process which is executed by the server computer that constitutes the content delivery server SV.

At the beginning of the process, the content delivery server SV determines whether an upload request of moving image data as content data has been issued from the personal computer PC (step S101).

If the content delivery server SV determines that the upload request has not been issued from the personal computer PC (No in step S101), the content delivery server SV then determines whether a delivery request of content data has been issued from any one of the signage devices 10 (step S102).

Here, if the content delivery server SV determines that the delivery request of content data has not been issued (No in step S102), the content delivery server SV returns to the process from step S101.

In this manner, by repeatedly executing the process of steps S101 and S102, the content delivery server SV waits for the upload request of moving image data from the personal computer PC, or the delivery request of content data from any one of the signage devices 10.

Here, the moving image data, which the personal computer PC is to upload, is composed of an image in which the entirety of the peripheral area in the projectable area PA, excluding the area of the shape of the screen panel SP, is formed of black pixels in accordance with the shape of the specific screen panel SP.

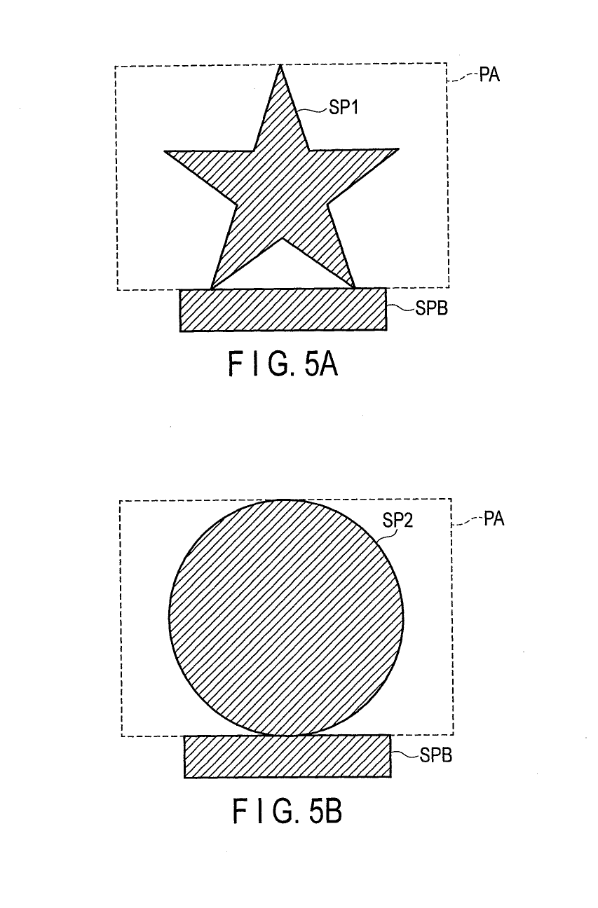

FIGS. 5A and 5B are views illustrating examples of the shape of the screen panel SP which is used in the signage device 10. FIG. 5A illustrates a screen panel SP1 of a pentagrammatic shape. The screen panel SP1 is formed integral with a panel base SPB for attachment to the signage device 10. The part of the screen panel SP1, other than the panel base SPB, falls within the projectable area PA.

FIG. 5B illustrates a screen panel SP2 of a circular shape. The screen panel SP2 is also formed integral with the panel base SPB for attachment to the signage device 10. The part of the screen panel SP2, other than the panel base SPB, falls within the projectable area PA.

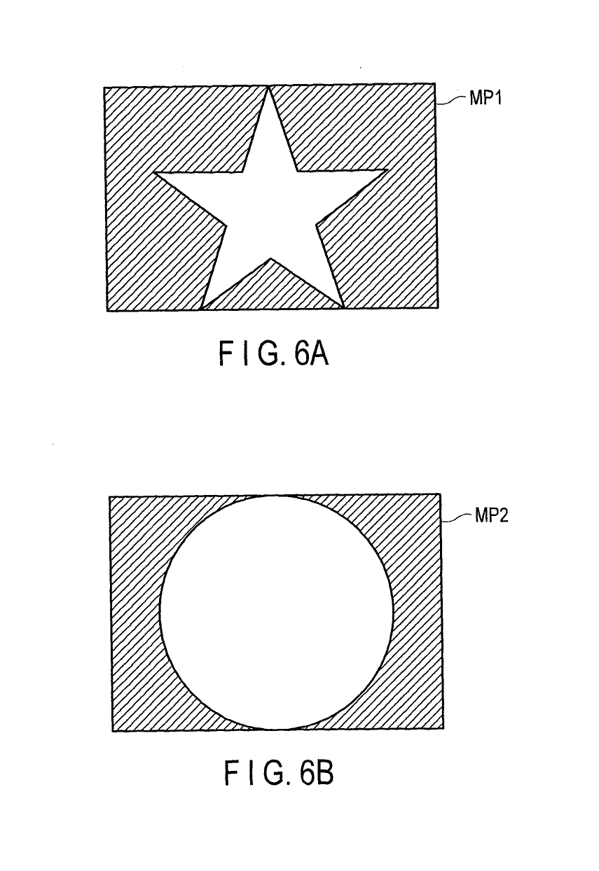

FIG. 6A illustrates a pixel configuration of moving image data which the personal computer PC provides for the screen panel SP1 and uploads to the content delivery server SV. As illustrated in FIG. 6A, the area, which is other than the area of the pentagrammatic screen panel SP1, is all formed of black pixels, such that an optical image is projected to only the range of the pentagrammatic screen panel SP1. Thereby, unnecessary light is not radiated to the user of the signage device 10.

FIG. 6B illustrates a pixel configuration of moving image data which the personal computer PC provides for the screen panel SP2 and uploads to the content delivery server SV. As illustrated in FIG. 6B, the area, which is other than the area of the circular screen panel SP2, is all formed of black pixels, such that an optical image is projected to only the range of the circular screen panel SP2. Thereby, unnecessary light is not radiated to the user of the signage device 10.

In the process of FIG. 4, if the content delivery server SV determines that the upload request has been issued from the personal computer PC (Yes in step S101), the content delivery server SV receives the moving image data which is uploaded from the personal computer PC (step S103), and then analyzes image data which constitutes the received moving image data, and calculates an area of pixels which are normally black (step S104).

For example, when moving image data is formed based on an MPEG (Moving Picture Experts Group) standard, analysis is executed based on, among three kinds of image data constituting a GOP (Group of Pictures), namely an I picture (Intra-Picture: intra-frame encoded image), a P picture (Predictive-Picture: inter-frame forward-directional predictive encoded image) and a B picture (Bidirectionary predictive-Picture: bidirectional predictive encoded image), only the image data of the I picture that enables formation of a single image independently by itself. Thereby, the time needed for the analysis can be shortened, and the area of the black pixels can efficiently be calculated.

In this manner, the content delivery server SV calculates the area of the black image where an optical image is not formed at the time of actual projection, thereby calculating, conversely, an effective area where an optical image is formed (step S105).

Based on this calculation result, the content delivery server SV compares the calculated effective area and the shape patterns of all screen panels SP which are prestored in the database, thereby determining type information which identifies the screen panel SP with a shape that is suited to the uploaded moving image data (step S106).

In addition, the content delivery server SV stores in the database the uploaded moving image data by associating the uploaded moving image data with the type information for identifying the screen panel SP, the type information being the determination result (step S107).

The content delivery server SV thus completes the series of processes relating to the upload of moving image data from the personal computer PC, and then returns to the process from step 5101.

Besides, in step 5102, if the content delivery server SV determines that the delivery request of content data has been issued from any one of the signage devices 10 (Yes in step S102), the content delivery server SV refers to a delivery history of content data to this signage device 10, based on identification ID information of the signage device 10 which the content delivery server SV receives together with this delivery request (step S109), and determines whether content data, which agrees with the shape of the screen panel SP of this signage device 10 and has not yet been delivered, is stored in the database (step S110).

Here, if the content delivery server SV determines that there is no content data which has not yet been delivered (No in step S110), the content delivery server SV creates and returns data for causing the signage device 10 to display a guide message such as “there is no deliverable content at present”, in response to the delivery request from the signage device 10, and returns to the process from step S101.

In addition, in step S110, if the content delivery server SV determines that content data, which agrees with the shape of the screen panel SP and has not yet been delivered, is stored in the database, the content delivery server SV reads out the corresponding content data from the database as requested, and delivers the corresponding content data to the signage device 10 (step S112), and returns to the process from step S101.

In this projection apparatus with the screen panel of a non-fixed shape, which is of such a rear-projection type that the screen panel that is the display unit is provided on the front side of the apparatus where the user is located, light in an area out of the range of the screen panel is directly radiated to the user. Thus, in this embodiment, unnecessary radiation can exactly be avoided.

As has been described above in detail, according to the present embodiment, content data including moving image data can be delivered to the signage device 10 on which the screen panel SP of a non-fixed shape is mounted, after the shape of the mounted screen panel SP is exactly recognized.

In addition, in the above-described embodiment, with respect to the moving image data which was uploaded from the personal computer PC, the range of the ineffective area of black pixels, which are not related to optical image formation and which block light, is analyzed through the entirety of the content of the image. From the range of the ineffective area, the shape of the screen, which is suited to the image projection, is detected. Therefore, the shape of the screen, which is capable of performing projection, can exactly be determined.

In the meantime, in the above embodiment, the signage device 10 was described as the rear-projection type projection apparatus as illustrated in FIG. 2 and FIG. 3. However, in the present invention, there are no restrictions to the direction of projection, etc.

Besides, the present invention is not limited to the above-described embodiment. In practice, various modifications may be made without departing from the spirit of the invention. In addition, the functions, which are executed in the above embodiment, may be properly combined and implemented as much as possible. The above-described embodiment includes various stages, and various inventions can be derived from proper combinations of structural elements disclosed herein. For example, even if some structural elements in all the structural elements disclosed in the embodiment are omitted, if advantageous effects can be obtained, the structure, in which the structural elements are omitted, can be derived as an invention.

What is claim is:

1. An image delivery apparatus comprising:
a storage configured to store content including an image; and
a communicator configured to:
accept a delivery request of content from an external device;
acquire information indicating a shape of a screen which the external device includes; and
deliver the content, which is stored in the storage, to the external device in accordance with the acquired information.

2. The image delivery apparatus of claim 1, further comprising:
a controller configured to detect the shape of the screen which is suited to image projection of the content stored in the storage,
wherein the communicator is configured to deliver the content, which is stored in the storage, to the external device in accordance with the acquired information and the shape of the screen detected by the controller.

3. The image delivery apparatus of claim 2, wherein the storage is configured to store information which indicates the shape of the screen suited to the image projection by a range of an ineffective area in the image, by associating the information with the content, the ineffective area being unrelated to optical image formation and blocking light.

4. An image delivery method in an apparatus including a storage configured to store content including an image, the method comprising:
an acceptance step of accepting a delivery request of content from an external device;
a shape acquisition step of acquiring information indicating a shape of a screen which the external device includes; and
a delivery step of delivering the content, which is stored in the storage, to the external device accepted in the acceptance step, in accordance with the information which was acquired in the shape acquisition step.

5. A computer readable medium on which a program is recorded, the program being executable by a computer having a storage configured to store content including an image, the program causing the computer to execute:
an acceptance process of accepting a delivery request of content from an external device;
a shape acquisition process of acquiring information indicating a shape of a screen which the external device includes; and
a delivery process of delivering the content, which is stored in the storage, to the external device accepted in the acceptance process, in accordance with the information acquired by the shape acquisition process.
